(19) United States
(12) Patent Application Publication
(10) Pub. No.: US 2025/0287317 A1
(43) Pub. Date: Sep. 11, 2025

(54) COMMUNICATION APPARATUS, CONTROL METHOD, AND COMPUTER-READABLE STORAGE MEDIUM

(71) Applicant: CANON KABUSHIKI KAISHA, Tokyo (JP)

(72) Inventor: KOJI YUKIMASA, Kanagawa (JP)

(21) Appl. No.: 19/215,513

(22) Filed: May 22, 2025

Related U.S. Application Data
(63) Continuation of application No. PCT/JP2023/038159, filed on Oct. 23, 2023.

(30) Foreign Application Priority Data
Nov. 30, 2022 (JP) 2022-191882

(51) Int. Cl. H04W 52/14; H04W 52/24; H04W 52/36

(52) U.S. Cl. CPC H04W 52/146; H04W 52/245; H04W 52/367

(57) ABSTRACT

A communication apparatus that executes inter-terminal communication complying with a cellular communication standard, decides which of the communication apparatus and a partner apparatus in the inter-terminal communication operates as a control terminal configured to control transmission power, and transmits, in a case where it is decided that the communication apparatus operates as the control terminal, a command to the partner apparatus, and controls transmission power of the partner apparatus by the command.

### CROSS-REFERENCE TO RELATED APPLICATIONS

This application is a Continuation of International Patent Application No. PCT/JP2023/038159, filed Oct. 23, 2023, which claims the benefit of Japanese Patent Application No. 2022-191882, filed Nov. 30, 2022, both of which are hereby incorporated by reference herein in their entirety.

### BACKGROUND

### Field of the Technology

The present disclosure relates to an inter-terminal communication technique complying with the 3rd Generation Partnership Project (3GPP®) standard.

### Description of the Related Art

A wireless communication system complying with a cellular communication standard such as Long Term Evolution (LTE) or 5th Generation (5G) by the 3rd Generation Partnership Project (3GPP®) is widely used. These cellular communication standards include a method in which a terminal communicates with another terminal via a base station as well as specifications regarding direct communication between terminals, which is called sidelink communication.

### CITATION LIST

### Patent Literature

PTL 1: Japanese Patent Laid-Open No. 2002-271263

In sidelink communication, transmission power when a terminal transmits a signal is fixed to a predetermined value. Therefore, the transmission power may become too large or too small in accordance with the positional relationship between terminals and the like. To the contrary, PTL 1 describes a transmission power control technique for inter-terminal communication. In the transmission power control technique, within the coverage of a control station, all terminals share flags each indicating whether each terminal can receive data from another terminal, and the transmission power of the self-apparatus is decided based on the flags. However, in the technique described in PTL 1, the terminal can only specify whether another terminal can receive transmitted power, and cannot perform highly accurate transmission power control.

### SUMMARY

The present disclosure provides a technique of allowing a communication apparatus that performs inter-terminal communication to perform highly accurate transmission power control.

According to one aspect of the present disclosure, there is provided a communication apparatus that executes inter-terminal communication complying with a cellular communication standard, comprising: one or more processors; and one or more memories that store a computer-readable instruction for causing, when executed by the one or more processors, the one or more processors to perform a control method comprising: deciding which of the communication apparatus and a partner apparatus in the inter-terminal communication operates as a control terminal configured to control transmission power; and transmitting, in a case where it is decided that the communication apparatus operates as the control terminal, a command to the partner apparatus, and controlling transmission power of the partner apparatus by the command.

Features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain principles of the disclosure.

FIG. 1 is a view for explaining sidelink communication.

FIG. 2 is a block diagram showing an example of the hardware configuration of a communication apparatus.

FIG. 3 is a block diagram showing an example of the functional configuration of the communication apparatus.

FIG. 4 is a sequence chart showing an example of the procedure of processing performed between communication apparatuses.

FIG. 5A is a view showing a physical layer frame format used in sidelink communication.

FIG. 5B is a view showing a physical layer frame format used in sidelink communication.

FIG. 6 is a flowchart illustrating an example of the procedure of processing executed in the communication apparatus.

### DESCRIPTION OF THE EMBODIMENTS

Hereinafter, embodiments will be described in detail with reference to the attached drawings. Note, the following embodiments are not intended to limit the scope of the claimed technical features. Multiple features are described in the embodiments, but limitation is not made to a technique that requires all such features, and multiple such features may be combined as appropriate. Furthermore, in the attached drawings, the same reference numerals are given to the same or similar configurations, and redundant description thereof is omitted.

### (Sidelink Communication)

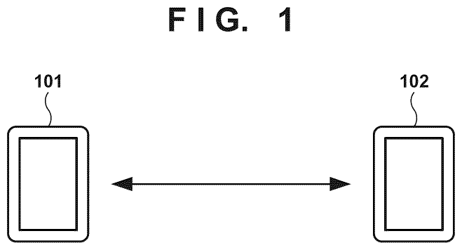

FIG. 1 is a view for explaining a form in which wireless communication is performed according to this embodiment. In this embodiment, communication complying with a cellular communication standard such as Long Term Evolution (LTE) or 5th Generation (5G) by the 3rd Generation Partnership Project (3GPP®) is performed. More specifically, each of communication apparatuses 101 and 102 is a terminal in a cellular communication system, and is configured to, for example, communicate with a base station existing nearby. On the other hand, in this embodiment, as shown in FIG. 1, the communication apparatuses 101 and 102 perform direct communication without interposing a base station. This embodiment assumes that direct communication is performed using NR (New Radio) sidelink communication or V2X (Vehicle-to-Everything) sidelink communication defined in the above-described cellular communication standard. This communication will be referred to as sidelink communication or SL communication hereinafter. Note that at least one of the communication apparatuses 101 and 102 may exist within a coverage area connectable to the base station or both the communication apparatuses 101 and 102 may exist outside the coverage area. Note that sidelink communication is merely an example of inter-terminal communication complying with the cellular communication standard, and the following discussion can also be applied to inter-terminal communication different from the above-described one defined as the sidelink communication. For example, the following discussion can be applied to inter-terminal communication in 5G-Advanced as a successor standard of 5G and inter-terminal communication in 6G as a further successor standard.

In this embodiment, when performing sidelink communication, the communication apparatuses 101 and 102 perform transmission power control. One of the communication apparatuses 101 and 102 operates as a control terminal that leads transmission power control, and the other apparatus operates as a controlled terminal that executes transmission power control under the control of the control terminal. Then, the control terminal decides, based on reception power of a radio signal from the partner apparatus (controlled terminal), transmission power to be used for transmission of a radio signal in the partner apparatus, and controls, using a transmission power control command, the partner apparatus to transmit a radio signal with the transmission power. Note that the roles of the control terminal and the controlled terminal may dynamically be decided, and can be decided based on, for example, a criterion to be described later.

Examples of the apparatus configuration of the communication apparatus that performs such processing and the procedure of processing to be executed will be described in detail below. Note that the communication apparatuses 101 and 102 will simply be referred to as “communication apparatuses” or UEs (User Equipments) hereinafter if it is unnecessary to particularly discriminate them.

### (Apparatus Configuration)

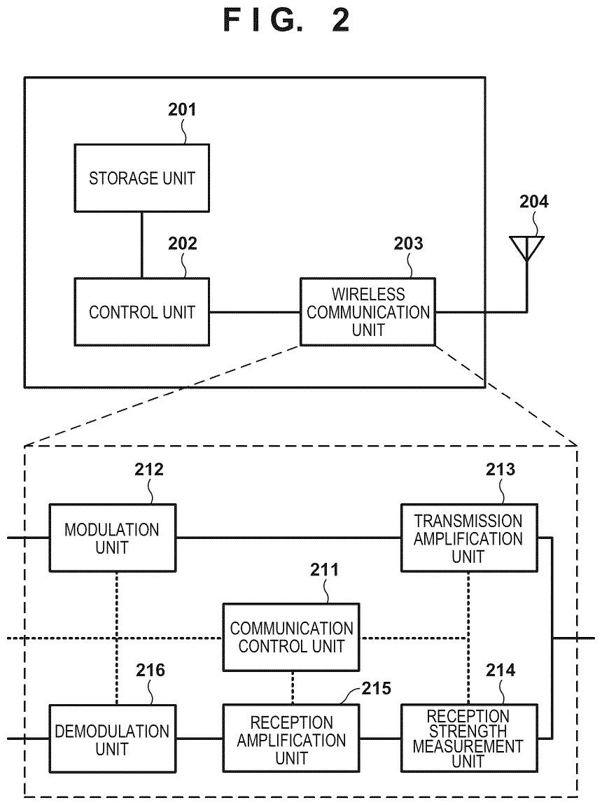

FIG. 2 shows an example of the hardware configuration of the communication apparatus. The communication apparatus includes, as the hardware configuration, a storage unit 201, a control unit 202, a wireless communication unit 203, and an antenna 204. Note that these hardware blocks are merely examples, and the communication apparatus may include, for example, more hardware blocks. Two or more hardware blocks shown in FIG. 2 may be implemented as one integrated hardware block, and one hardware block may be divided into a plurality of hardware blocks.

The storage unit 201 is configured to include, for example, a memory such as a Read Only Memory (ROM) and a Random Access Memory (RAM). The storage unit 201 stores programs for performing various kinds of operations to be described later, and various kinds of information such as communication parameters for wireless communication. Note that other than the memory such as the ROM and the RAM, the storage unit 201 may include a storage medium such as a flexible disk, a hard disk, an optical disk, a magneto-optical disk, a CD-ROM, a CD-R, a magnetic tape, a nonvolatile memory card, or a DVD. The storage unit 201 may include a plurality of memories.

The control unit 202 is formed by, for example, a processor such as a CPU or an MPU, an Application Specific Integrated Circuit (ASIC), a Digital Signal Processor (DSP), a Field Programmable Gate Array (FPGA), or the like. Note that CPU is an acronym for Central Processing Unit, and MPU is an acronym for Micro Processing Unit. For example, the control unit 202 controls the whole communication apparatus by executing the programs stored in the storage unit 201. Note that the control unit 202 may control the communication apparatus by cooperation of the programs stored in the storage unit 201 and an Operating System (OS). The control unit 202 may include a plurality of processors such as a multi-core processor.

The wireless communication unit 203 is configured to include hardware (for example, a radio frequency (RF) chip, a baseband chip, or the like) for performing wireless communication complying with the 3GPP® cellular communication standard. The wireless communication unit 203 controls the corresponding antenna 204 to transmit/receive a radio signal for wireless communication. Note that FIG. 2 shows the configuration including one antenna 204 but a plurality of antennas may be used. For example, the wireless communication unit 203 is configured to execute sidelink communication such as NR sidelink communication or V2X sidelink communication with another UE in addition to communication with the base station. As shown in FIG. 2, the wireless communication unit 203 is configured to include a communication control unit 211, a modulation unit 212, a transmission amplification unit 213, a reception strength measurement unit 214, a reception amplification unit 215, and a demodulation unit 216.

The communication control unit 211 controls other components (the modulation unit 212 to the demodulation unit 216) to perform wireless communication.

The modulation unit 212 performs primary modulation and secondary modulation for transmission data transmitted by wireless communication, and further performs processing such as frequency conversion, thereby generating a signal transmittable via the antenna 204. In this example, primary modulation can be processing of mapping a data sequence to a signal point within the IQ plane formed from an in-phase component and a quadrature component. As the modulation scheme of primary modulation, for example, PSK (Phase Shift Keying) or QAM (Quadrature Amplitude Modulation) is used. Note that PSK includes BPSK (Binary PSK) and QPSK (Quadrature PSL), and QAM includes 16QAM, 64QAM, and 256QAM. A modulation scheme in which the number of points on the IQ plane is larger can increase a data amount transmittable at one signal point. Secondary modulation is modulation on the frequency axis, and for example, Orthogonal Frequency Division Multiplexing (OFDM), spreading using a spread code, frequency hopping, and the like are performed. Frequency conversion includes, for example, conversion of a signal of a baseband frequency into a signal of a radio frequency (RF). The signal modulated by the modulation unit 212 is amplified by the transmission amplification unit 213, and sent via the antenna 204.

A signal sent from another terminal is received via the antenna 204, and the strength of the signal is measured by the reception strength measurement unit 214. The received signal is amplified by the reception amplification unit 215, and input to the demodulation unit 216. The demodulation unit 216 converts the input signal into, for example, a baseband signal, and performs secondary demodulation corresponding to the secondary modulation and primary demodulation corresponding to the primary modulation for the converted signal, thereby acquiring the data transmitted from the other apparatus. The reception amplification unit 215 is configured to include, for example, a Low Noise Amplifier (LNA), and can amplify the received signal of small power received via the antenna 204. Note that the power consumption of the reception amplification unit 215 generally changes depending on the input signal strength. For example, as the input signal strength is lower, the power consumption can be larger. On the other hand, if the input signal strength is too high, the signal may be distorted, thereby degrading demodulation performance. Therefore, if highly accurate transmission power control to be described later is performed, it is possible to hold sufficiently high demodulation performance while suppressing an increase in power consumption.

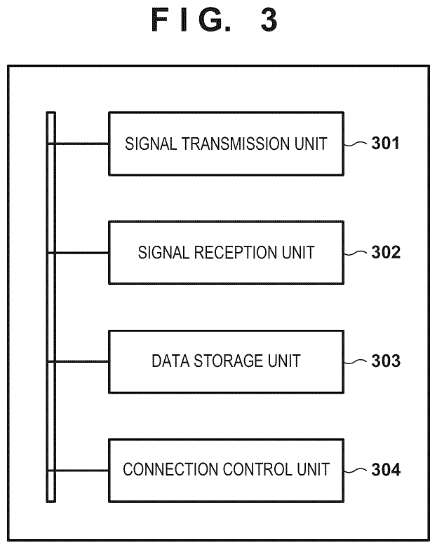

FIG. 3 is a block diagram showing an example of the functional configuration of the communication apparatus. Each function shown in FIG. 3 can be implemented when, for example, the communication control unit 211 executes processing programmed in advance. Alternatively, each function may be implemented when the control unit 202 executes a program stored in the storage unit 201. Alternatively, for example, each function may be implemented when the communication control unit 211 operates under the control of the control unit 202. Note that the example of the functional configuration shown in FIG. 3 is merely an example, at least some of the functions may be omitted, and additional functions may be provided. The functional blocks are schematically shown. A plurality of functional blocks may be integrated into one functional block, and one function block may be divided into a plurality of functional blocks. A signal transmission unit 301 and a signal reception unit 302 execute wireless communication with another terminal apparatus or a base station in compliance with a communication standard such as LTE or 5G. A data storage unit 303 executes control to store software, information concerning wireless communication, and the like in the storage unit 201. A connection control unit 304 executes control to establish or disconnect connection to a terminal or a core network function in various layers such as a Radio Resource Control (RRC) layer. The connection control unit 304 executes, for example, transmission/reception of an RRC message, transmission/reception of information of a physical layer or a Media Access Control (MAC) layer, and the like.

### (Procedure of Processing)

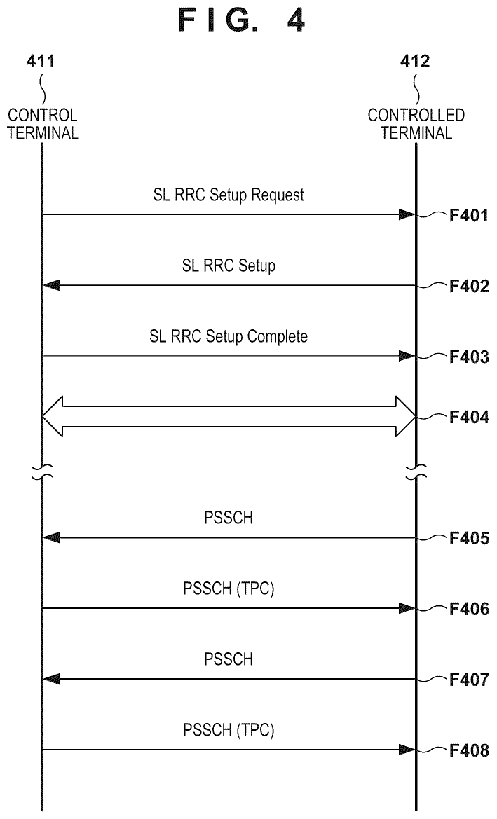

Subsequently, an example of the procedure of communication processing according to this embodiment will be described with reference to FIG. 4. FIG. 4 shows a processing example according to this embodiment in a case where one of the above-described communication apparatuses 101 and 102 functions as a control terminal 411 and the other apparatus functions as a controlled terminal 412. Out of the communication apparatuses 101 and 102, for example, the apparatus on the request side of an RRC connection setup can function as a control terminal, and the apparatus on the request reception side can function as a controlled terminal. However, this is merely an example, and the apparatus on the request reception side may function as a control terminal and the apparatus on the request transmission side may function as a controlled terminal. Note that whether the apparatus operates as a control terminal or a controlled terminal is decided based on whether the apparatus is the apparatus on the setup request transmission side or the apparatus on the setup request reception side. The role decision may be made based on another message in the RRC layer. For example, the role decision may be made based on the apparatus is the apparatus on the transmission side or reception side of a reset message (RRC Reconfiguration). Furthermore, each of the communication apparatuses 101 and 102 can request Channel State Information (CSI) of the partner apparatus. The apparatus on the request side of the CSI may function as a control terminal and the other apparatus may function as a controlled terminal. Alternatively, the apparatus on the request side of the CSI may function as a controlled terminal and the other apparatus may function as a control terminal. Note that “control terminal” indicates the communication apparatus that leads transmission power control (TPC) (issues a TPC command), and need not perform control other than TPC.

In the processing shown in FIG. 4, one of the communication apparatuses 101 and 102 transmits a RRC connection setup request (SL RRC Setup Request) for sidelink communication (F401). In this example, assume that the apparatus on the request transmission side starts to operate as the control terminal 411. Upon receiving the setup request, the other apparatus starts to operate as the controlled terminal 412, and transmits an RRC connection setup message (SL RRC Setup) to the control terminal 411 (F402). After that, the control terminal 411 transmits a response message (SL RRC Setup Complete) to the controlled terminal 412 (F403), thereby establishing connection for sidelink communication. After that, the control terminal 411 and the controlled terminal 412 execute sidelink communication (direct communication between the terminals) (F404).

Assume here that the controlled terminal 412 transmits a radio signal (Physical Sidelink Shared Channel (PSSCH)) including data (F405), and the received signal strength of the radio signal in the control terminal 411 falls outside the appropriate input range of the reception amplification unit 215. In this case, the control terminal 411 transmits, to the controlled terminal 412, a radio signal (PSSCH) including a transmission power control (TPC) command for appropriately setting transmission power so that the radio signal transmitted by the controlled terminal 412 is received with appropriate received signal strength (F406). The controlled terminal 412 extracts the TPC command from the received radio signal, increases/decreases transmission power in accordance with the TPC command, and sends a radio signal using the changed transmission power (F407). Furthermore, the control terminal 411 transmits a radio signal to the controlled terminal 412, as needed (F408).

Note that the control terminal 411 may change the transmission power of the self-apparatus in, for example, F406 or F408. For example, if the received signal strength of the radio signal from the controlled terminal 412 is higher than an appropriate value, the control terminal 411 can estimate that a signal transmitted by the self-apparatus is received by the controlled terminal 412 with signal strength higher than the appropriate value. Then, if the control terminal 411 instructs the controlled terminal 412 to decrease the transmission power by a predetermined value, the control terminal 411 can also decrease the transmission power of the self-apparatus by the predetermined value. Similarly, if the control terminal 411 instructs the controlled terminal 412 to increase the transmission power by a predetermined value, the control terminal 411 can also increase the transmission power of the self-apparatus by the predetermined value. If initial transmission power at the start of sidelink communication between the control terminal 411 and the controlled terminal 412 is the predetermined value, this processing can keep matching the transmission powers of the control terminal 411 and the controlled terminal 412. If the performance of an amplifier such as a Low Noise Amplifier (LNA) in the reception amplification unit 215 is different between the control terminal 411 and the controlled terminal 412, the appropriate values of the input signals can be different. Therefore, for example, when establishing connection, information indicating the performance of the amplifier may be exchanged using capability information (UE Capability) or the like, and the control terminal 411 may perform transmission power control based on the information. Note that, for example, the control terminal 411 may change the transmission power of the self-apparatus at the time of transmitting the TPC command in F406 or may perform similar transmission power change processing at another timing such as F408. The control terminal 411 may change only the transmission power of the controlled terminal 412, and need not change the transmission power of the self-apparatus. Alternatively, the control terminal 411 need not change the transmission power of the controlled terminal 412 while changing the transmission power of the self-apparatus.

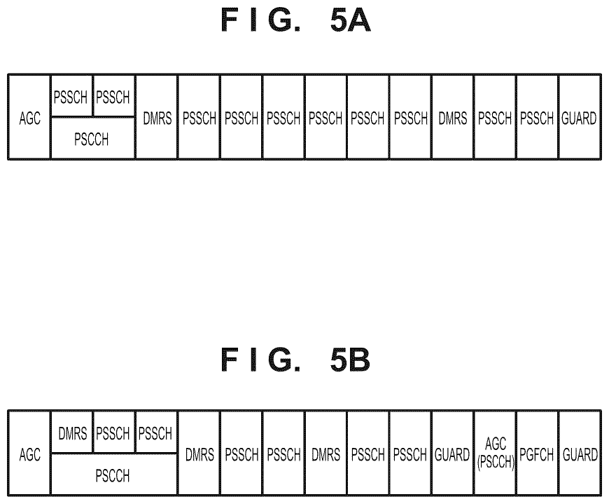

The control terminal 411 can transmit a transmission power control command to the controlled terminal 412 using, for example, a physical layer frame format for sidelink communication shown in FIG. 5A or 5B. FIG. 5A shows a format that includes a Physical Sidelink Control Channel (PSCCH) of two symbols and a Demodulation Reference Signal (DMRS) for a PSSCH of two symbols, and includes no Physical Sidelink Feedback Channel (PSFCH). On the other hand, FIG. 5B shows a format including a PSCCH of three symbols, a DMRS for a PSSCH of three symbols, and a PSFCH. In these formats, for example, a TPC command can be included in the PSSCH, PSCCH, or PSFCH. In sidelink communication, communication control is performed based on transmitted/received control information such as a Modulation Coding Scheme (MCS) and a Channel State Information (CSI) Request.

The TPC command can include the value of a change step indicating the change width of the transmission power, and a bit (increase/decrease bit) indicating increase or decrease of the transmission power. Upon receiving the TPC command, if the increase/decrease bit indicates to increase the power, the controlled terminal 412 increases the transmission power by the value of the change step. If the increase/decrease bit in the TPC command indicates to decrease the power, the controlled terminal 412 decreases the transmission power by the value of the change step. The TPC command may include a target power value. In this case, the controlled terminal 412 can set the transmission power to be the target power value. A combination of the value of the change step and the increase/decrease bit or the TPC command including the target power value may be defined as an option. In this case, by clearing the combination of the value of the change step and the increase/decrease bit or the TPC command including the target power value, it is possible to prevent power control from being performed. Note that in the above-described format examples, transmission power control is performed in the physical layer. However, for example, using a message in the upper layer such as the Media Access Control (MAC) layer, transmission power control may be performed in the layer.

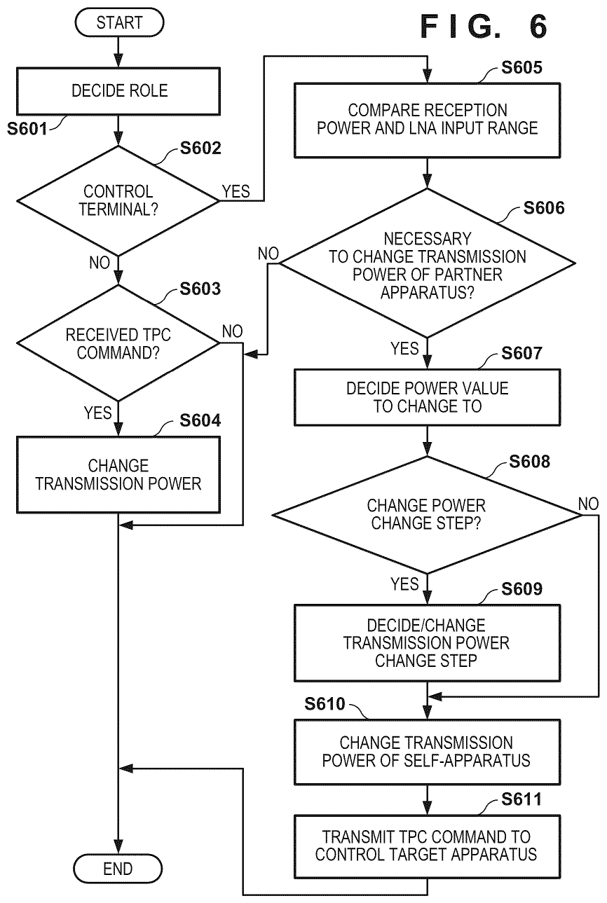

Subsequently, an example of the procedure of processing executed by the communication apparatus will be described with reference to FIG. 6. Note that the processing example shown in FIG. 6 is merely an example. For example, some of processing steps may be omitted and additional processing steps may be provided. A plurality of processing steps may be integrated into one processing step, and one processing step may be divided into a plurality of processing steps. Furthermore, the order of the processing steps may be changed.

First, the communication apparatus decides whether to operate as a control terminal or a controlled terminal (step S601). For example, as described above, based on whether the communication apparatus is the apparatus on the transmission side of a message such as a Radio Resource Control (RRC) layer setup request or a reset message or the apparatus on the reception side of the message, the communication apparatus can decide whether to operate as a control terminal. Alternatively, based on whether the communication apparatus is the apparatus on the transmission side of a request message concerning a Hybrid Automatic Repeat Request (HARQ) or Channel State Information (CSI) or the apparatus on the reception side of the message, the communication apparatus may decide whether to operate as a control terminal. The communication apparatus may decide that one of the self-apparatus and the partner apparatus, which has a larger value of identification information such as a device ID, MAC address, or IMSI, operates as a control terminal and the other apparatus which has a smaller value operates as a controlled terminal. Alternatively, the communication apparatus may decide that one apparatus which has a smaller value operates as a control terminal and the other apparatus which has a larger value operates as a controlled terminal.

If the communication apparatus operates as a controlled terminal (NO in step S602), it determines whether the TPC command is received from the partner apparatus operating as a control terminal (step S603). Then, if no TPC command is received (NO in step S603), the communication apparatus directly ends the processing without performing any processing. On the other hand, if the TPC command is received (YES in step S603), the communication apparatus changes the transmission power in accordance with the command (step S604), and continues communication.

If the communication apparatus operates as a control terminal (YES in step S602), it measures the reception strength of a radio signal sent from the partner apparatus, and compares a value Pr representing the reception power with a value Pin representing the input range of the reception amplification unit 215 of the self-apparatus (step S605). Then, for example, based on the comparison result, the communication apparatus decides whether to change the transmission power of the partner apparatus (step S606). The value Pr representing the reception power can be, for example, the average reception power of signals within a predetermined period (as an example, the average reception power of the overall radio signal transmitted at one time). For example, the value Pr representing the reception power can be calculated based on the reception power of a reference signal and the like. The value Pin representing the input range can be, for example, the range of the input power value of the amplifier (for example, an LNA) that can appropriately amplify the power within the range from the lower limit input power value which can sufficiently suppress the influence of noise to the upper limit input power value with which the signal is not distorted by clipping or the like. In this case, if, for example, Pr exceeds the upper limit of Pin or Pr is smaller than the lower limit of Pin, the communication apparatus decides to change the transmission power of the partner apparatus. The value Pin representing the input range may be the median of a proper input power level. In this case, if the difference between Pr and Pin exceeds a predetermined value, the communication apparatus can decide to change the transmission power of the partner apparatus. Note that if Pr has been an inappropriate value, as compared with Pin, for a predetermined time or more, the communication apparatus may decide to change the transmission power of the partner apparatus. That is, even if Pr is an inappropriate value, as compared with Pin, if this state does not continue for the predetermined time or more, the communication apparatus need not change the transmission power of the partner apparatus. The communication apparatus may decide to control the transmission power of the partner apparatus, for example, regardless of the relationship between Pr and Pin. For example, if a predetermined time or more has elapsed since transmission power control was executed last time, the communication apparatus may decide to set the transmission power of the partner apparatus. Alternatively, if the change amount of Pr within a predetermined time exceeds a predetermined value, the communication apparatus may decide to change the transmission power of the partner apparatus.

If the communication apparatus decides not to change the transmission power of the partner apparatus (NO in step S606), it ends the processing. On the other hand, if the communication apparatus decides to change the transmission power of the partner apparatus (YES in step S606), it decides a changed power value P_controlled (step S607). For example, based on the values Pr and Pin, the communication apparatus can decide how much the transmission power is to be increased or decreased. For example, the communication apparatus decides P controlled so that Pr falls within the appropriate input range. If the predetermined time or more has elapsed since transmission power control was executed last time, the communication apparatus can decide P_controlled so that the transmission power becomes a predetermined value. The communication apparatus may change the transmission power of the self-apparatus in addition to the transmission power of the partner apparatus, and may decide a power value P_control for this.

The communication apparatus determines whether to change power change steps ΔP_control and ΔP_controlled each of which defines how much the transmission power is to be increased or decreased (step S608). Note that ΔP_control represents the power change step of the transmission power of the control terminal 411, and ΔP_controlled represents the power change step of the transmission power of the controlled terminal 412. If the power change step is changed (YES in step S608), the communication apparatus decides and changes the power change step (step S609). On the other hand, if the power change step is not changed (NO in step S608), the communication apparatus does not perform the processing of deciding and changing the power change step in step S609.

For example, in step S607, the communication apparatus may determine, based on the difference between Pr and Pin, whether to change the power change step. For example, the communication apparatus may decide, as the power change step, the width of the power to be increased or decreased in order to set Pr to an appropriate value. For example, |Pr−Pin| may be used as the power change step, or α×|Pr−Pin| (0<α<1) may be used as the power change step. Furthermore, for example, in a case where the communication apparatus knows the moving amount of each of the self-apparatus and the partner apparatus, if the moving amount within a predetermined period is equal to or larger than a predetermined value, the power change step may be changed. For example, if at least one of the moving amounts of the self-apparatus and the partner apparatus is equal to or larger than the predetermined value, the communication apparatus can increase the power change step to make the transmission power quickly follow the appropriate value. If the moving amount is large, it is assumed that a communication status largely changes within a short period, and thus the appropriate transmission power can largely change within a short period. Therefore, by increasing the power change step to improve the followability of the transmission power, the communication apparatus can improve the probability that communication can be performed with the appropriate transmission power. On the other hand, if the moving amount is small, it is assumed that the communication status is almost constant. Therefore, the communication apparatus can decrease the power change step, thereby suppressing the probability that the transmission power becomes an inappropriate value. Note that the moving amount can be calculated or estimated based on, for example, a measurement value obtained by positioning or an acceleration sensor, and an image captured by the image capturing function of the communication apparatus or the partner apparatus.

Then, the communication apparatus changes the transmission power of the self-apparatus by ΔP_control (step S610), and transmits the TPC command to change the transmission power of the partner apparatus by ΔP_controlled (step S611), thereby ending the processing.

With the above-described processing, it is possible to highly accurately perform transmission power control in inter-terminal communication complying with the cellular communication standard. Note that the above-described configuration example and processing example can arbitrarily used in combination, unless otherwise specified.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

1. A communication apparatus that executes inter-terminal communication complying with a cellular communication standard, comprising:
one or more processors; and
one or more memories that store a computer-readable instruction for causing, when executed by the one or more processors, the one or more processors to perform a control method comprising:
deciding which of the communication apparatus and a partner apparatus in the inter-terminal communication operates as a control terminal configured to control transmission power; and
transmitting, in a case where it is decided that the communication apparatus operates as the control terminal, a command to the partner apparatus, and controlling transmission power of the partner apparatus by the command.

2. The communication apparatus according to claim 1, wherein the control method further comprises measuring received signal strength of a radio signal sent from the partner apparatus,
wherein the communication apparatus controls the transmission power of the partner apparatus based on the measured received signal strength.

3. The communication apparatus according to claim 2, wherein the communication apparatus controls the transmission power of the partner apparatus further based on an input range of an amplifier configured to amplify the radio signal sent from the partner apparatus.

4. The communication apparatus according to claim 1, wherein the communication apparatus further controls transmission power of the communication apparatus.

5. The communication apparatus according to claim 4, wherein the control method further comprises measuring received signal strength of a radio signal sent from the partner apparatus,
wherein the communication apparatus controls the transmission power of the communication apparatus based on the measured received signal strength.

6. The communication apparatus according to claim 1, wherein the communication apparatus decides that an apparatus which has transmitted a predetermined signal, out of the communication apparatus and the partner apparatus, operates as the control terminal.

7. The communication apparatus according to claim 6, wherein the predetermined signal is one of a Radio Resource Control (RRC) layer message, a Channel State Information (CSI) request, or a Hybrid Automatic Repeat Request (HARQ) message.

8. The communication apparatus according to claim 1, wherein the communication apparatus decides that an apparatus which has received a predetermined signal, out of the communication apparatus and the partner apparatus, operates as the control terminal.

9. The communication apparatus according to claim 8, wherein the predetermined signal is one of a Radio Resource Control (RRC) layer message, a Channel State Information (CSI) request, or a Hybrid Automatic Repeat Request (HARQ) message.

10. The communication apparatus according to claim 1, wherein the communication apparatus decides whether to transmit the command, and then transmits the command to the partner apparatus in a case where it is decided to transmit the command, and does not transmit the command to the partner apparatus in a case where it is decided not to transmit the command.

11. The communication apparatus according to claim 10, wherein the control method further comprises measuring received signal strength of a radio signal sent from the partner apparatus,
wherein in a case where a change amount of the received signal strength within a predetermined time is not smaller than a predetermined value, the communication apparatus decides to transmit the command.

12. The communication apparatus according to claim 10, wherein based on a fact that a predetermined time has elapsed since the command was transmitted, the communication apparatus decides to transmit the next command.

13. The communication apparatus according to claim 1, wherein the communication apparatus sets a change width to be used to change transmission power, and transmits, as the command, information indicating the change width and information indicating whether to increase or decrease the transmission power to the partner apparatus.

14. The communication apparatus according to claim 13, wherein the control method further comprises measuring received signal strength of a radio signal sent from the partner apparatus,
wherein the communication apparatus sets the change width based on a change amount of the received signal strength or based on a moving amount within a predetermined period in at least one of the communication apparatus and the partner apparatus.

15. The communication apparatus according to claim 4, wherein the communication apparatus sets a change width to be used to change transmission power, and increases or decreases the transmission power of the communication apparatus by the change width.

16. The communication apparatus according to claim 15, wherein the control method further comprises measuring received signal strength of a radio signal sent from the partner apparatus,
wherein the communication apparatus sets the change width based on a change amount of the received signal strength or based on a moving amount within a predetermined period in at least one of the communication apparatus and the partner apparatus.

17. A communication apparatus that executes inter-terminal communication complying with a cellular communication standard, comprising:
one or more processors; and
one or more memories that store a computer-readable instruction for causing, when executed by the one or more processors, the one or more processors to perform a control method comprising:
deciding which of the communication apparatus and a partner apparatus in the inter-terminal communication operates as a control terminal configured to control transmission power; and
in a case where it is decided that the partner apparatus operates as the control terminal,
receiving a command for controlling transmission power from the partner apparatus, and
controlling, based on the command, transmission power of a radio signal to be transmitted to the partner apparatus.

18. A control method executed by a communication apparatus that executes inter-terminal communication complying with a cellular communication standard, comprising:
deciding which of the communication apparatus and a partner apparatus in the inter-terminal communication operates as a control terminal configured to control transmission power; and
transmitting, in a case where it is decided that the communication apparatus operates as the control terminal, a command to the partner apparatus, and controlling transmission power of the partner apparatus by the command.

19. A control method executed by a communication apparatus that executes inter-terminal communication complying with a cellular communication standard, comprising:
deciding which of the communication apparatus and a partner apparatus in the inter-terminal communication operates as a control terminal configured to control transmission power; and
in a case where it is decided that the partner apparatus operates as the control terminal,
receiving a command for controlling transmission power from the partner apparatus, and
controlling, based on the command, transmission power of a radio signal to be transmitted to the partner apparatus.

20. A non-transitory computer-readable storage medium that stores a program for causing a computer included in a communication apparatus, which executes inter-terminal communication complying with a cellular communication standard, to execute a control method comprising:
deciding which of the communication apparatus and a partner apparatus in the inter-terminal communication operates as a control terminal configured to control transmission power; and
transmitting, in a case where it is decided that the communication apparatus operates as the control terminal, a command to the partner apparatus, and controlling transmission power of the partner apparatus by the command.

21. A non-transitory computer-readable storage medium that stores a program for causing a computer included in a communication apparatus, which executes inter-terminal communication complying with a cellular communication standard, to execute a control method comprising:
deciding which of the communication apparatus and a partner apparatus in the inter-terminal communication operates as a control terminal configured to control transmission power; and
in a case where it is decided that the partner apparatus operates as the control terminal,
receiving a command for controlling transmission power from the partner apparatus, and
controlling, based on the command, transmission power of a radio signal to be transmitted to the partner apparatus.
